(19) United States
(12) Patent Application Publication
(10) Pub. No.: US 2010/0167255 A1
(43) Pub. Date: Jul. 1, 2010

(54) SYSTEM AND METHOD FOR GENERATING CUSTOMIZED VISUALLY-BASED LESSONS

(76) Inventors: Howard Shane, Tuftonboro, NH (US); Terence Michael Murphy, Shaker Heights, OH (US); Paul Michael Allen, Shaker Heights, OH (US); Lauren Michelle Stafford, University Heights, OH (US); Jeffrey Allan Richards, Cleveland, OH (US); Douglas Martin Pierce, Perry, OH (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/663,317

(22) PCT Filed: Jun. 9, 2008
(86) PCT No.: PCT/US08/66316

§ 371 Date: Dec. 7, 2009

Related U.S. Application Data
(60) Provisional application No. 60/942,587, filed on Jun. 7, 2007.

(51) Int. Cl. G09B 5/00; G09B 7/00

(52) U.S. Cl. 434/307 R; 434/350

(57) ABSTRACT

An interactive visually-based educational system and method that provides improved teacher-student, parent-teacher and teacher-teacher communication and collaboration. A plurality of data, such as video files, audio files, image files, document files, lesson templates, animations and the like, are received from a teacher, a supervisor, and the like, via a computer network. The received data is stored in a dynamic digital image library. The dynamic digital image library includes means for organizing the received data into easily identifiable and searchable curriculum categories. The received data is further used for generating visually-based lessons corresponding to the plurality of categories associated therewith, which lessons are stored in a digital interactive visual lesson library. The stored visually-based lessons are customized using personalized and other additional data and stored. The customized personalized visually-based lessons are interactively accessed via corresponding applications by associated students, teachers, and parents.

### CROSS-REFERENCE TO RELATED APPLICATIONS

This Application claims priority to U.S. Provisional Patent Application No. 60/942,587 filed Jun. 7, 2007, titled INTERACTIVE EDUCATIONAL VISUALLY-BASED SYSTEM AND METHOD, the entirety of which is incorporated herein.

### BACKGROUND OF THE INVENTION

The subject application is directed to generating interactive visually-based educational lessons. More particularly, the subject application is directed to an interactive visually-based educational system and method implemented via a computer network. The subject application is an advanced visual tool designed specifically for use in the educational process and treatment of autistic children, but can be used by any individuals and groups that prefer the permanence of visual stimuli.

Autism is a complex, enduring, neurobiological condition that affects communication and social interaction. Children diagnosed on the autism spectrum suffer from a bewildering array of problems. The symptoms and deficits of such children range from mild to severe, and may include an inability to speak, social withdrawal, preoccupation with routine, repetitive behaviors, sensory disturbances, and frequent tantrums. Over 50 percent of autistic children are nonverbal, and many are unable to interact with others beyond the most rudimentary levels. These deficiencies commonly interfere with the learning process and the ability to participate meaningfully in the community.

Recent teaching innovations involve visual learning interventions for autistic children. These new teaching methods are often individualized to each student. The teaching methods are highly language-focused and use “visual supports” to facilitate communication and development of language. These types of lessons further allow the autistic students to build their knowledge base and improve their practical life skills. It has also been shown that autistic children respond very well to visual teaching lessons.

Visual teaching supports are becoming widely accepted as state-of-the-art teaching tools for classroom and individual teaching, but good visual-based lessons are time consuming and costly to develop. Existing image library software is unsophisticated, and teachers everywhere “recreate the wheel” by redeveloping individual visual supports for their students. Once the visuals are printed and laminated, they are used in class, and then filed in individual teacher archives. Limited access to the lesson plans of colleagues severely limits a teacher's ability to share, compare and enhance visual supports. Additionally, parents do not have access to visual supports and lessons used in the schools.

### SUMMARY OF THE INVENTION

In accordance with one embodiment of the subject application, there is provided an interactive visually-based educational system and method.

Further, in accordance with one embodiment of the subject application, there is provided an interactive visually-based educational system and method implemented via a computer network.

Yet further, in accordance with one embodiment of the subject application, there is provided a system and method for generating interactive visually-based lessons.

Still further in accordance with one embodiment of the subject application, there is provided an interactive visually-based education system and method. Visually-based lesson data representing at least one visually-based lesson is first received via an associated computer network. Multiple visually-based lessons are stored in an associated visually-based lesson library accessible via the computer network. Each of the stored lessons is then organized into at least one searchable lesson category in the lesson library, such as an academic category, a behavioral category, a language category, a functional category, and a skill category. Component data representing a component that includes video data, image data, audio data, document data, or animation data is then received and stored in an associated dynamic digital library. Each of the component files are then organized into at least one searchable component category in the digital library. Selection data corresponding to at least one selected lesson category is then received from an associated user, whereupon category data is retrieved from the lesson library in accordance with received lesson selection data. Thereafter, display data representing at least one visually-based lesson corresponding to the selected category is generated via an associated display.

Further, in accordance with one embodiment of the subject application, there is provided an interactive visually-based educational system including means adapted for receiving from at least one first associated user, such as a teacher, a parent, a mentor, a supervisor, and the like, via a computer network, a plurality of data, such as, for example and without limitation, video files, audio files, image files, document files, animations and the like, and means adapted for storing the received data in an associated dynamic digital image library. The dynamic digital image library includes means for organizing the received data into easily identifiable and searchable categories. The searchable categories include, for example and without limitation, the following categories: parts of language, such as nouns, verbs, adjectives, and the like, associations for locations, associations for functions, and the like. The system further includes means adapted for retrieving by at least one first associated user, from the associated dynamic digital image library via the computer network, category data representative of at least one category of a plurality of categories. The system also includes generating means adapted for generating, via an associated display, display data representing at least one visually-based lesson corresponding to the at least one category of the plurality of categories associated therewith. The system further includes means adapted for storing a plurality of visually-based lessons in an associated digital visually-based lesson library.

The system further includes means for receiving, from at least one first associated user, such as a teacher, a supervisor, and the like, selection data representing at least one of a plurality of categories, such as an academic category, a behavior category, a language category, a social/functional skill category, and the like, and means for displaying the at least one of a plurality of categories, on an associated display. Additionally, the system includes means adapted for retrieving, from the associated digital interactive visual lesson library via the computer network, at least one of the plurality of visually-based lessons corresponding to the at least one selected category and generating means adapted for generating, via the associated display, display data representative of the retrieved lessons. The system also comprises selection means adapted for selecting at least one of the retrieved visually-based lessons for customization. The system further comprises retrieval means adapted for retrieving, from the associated digital interactive visual lesson library, a plurality of component files associated with the category corresponding to the selected lesson and means adapted for generating a display of the retrieved component files. The system also includes receiving means adapted for receiving selection data representative of at least one component file for incorporation into a customized lesson. In addition, the system includes generating means adapted for generating at least one customized lesson inclusive of the selected visually-based lesson and at least one selected component file and storage means adapted for storing, in an associated storage, the at least one customized visually-based lesson.

The system further includes means for receiving, from at least one second associated user, such as a student, selection data representing at least one of a plurality of categories, such as an academic category, a behavior category, a language category, a social/functional skill category, and the like and means for displaying the at least one of a plurality of categories, on an associated display. Additionally, the system includes means adapted for retrieving, from the associated digital interactive visual lesson library via the computer network, at least one of the plurality of visually-based lessons corresponding to the at least one selected category and generating means adapted for generating, via the associated display, display data representative of the retrieved lessons. In one embodiment, the display data is representative of a retrieved customized visually-based lesson.

Further, in accordance with one embodiment of the subject application, there is provided an interactive educational system that employs a visual language learning solution. The system is organized as a web infrastructure and includes a dynamic digital image library, which are an, ever-expanding, web-based warehouse of visual images and a set of interactive visual lesson templates. The visual images and interactive visual lesson templates include static images, text, audio, games, video and animations organized into easily identifiable and searchable curriculum categories, the latter enabling teachers to more quickly and easily create, access and modify teaching materials tailored to students' individual needs. The system further includes a digital interactive visual lesson library, at least one first user device, such as a teacher device, at least one second user device, such as a student device, and lesson builder software. The at least one teacher device is representative of any personal computing device known in the art, including, for example and without limitation, a computer workstation, a laptop computer, a personal computer, a personal data assistant, a web-enabled cellular telephone, a smart phone, a proprietary network device, or other web-enabled electronic device. The at least one student device is, preferably, portable and implemented as a tablet computer including a durable touch screen. More preferably, the tablet computer is personalized using unique colors, images, favorite characters and graphic schemes. However, the student device is capable of being implemented as any personal computing device known in the art.

The lesson builder software is capable of being an independent module, and also is capable of being included in the digital interactive visual lesson library. The digital interactive visual lesson library is adapted for storing and outputting visual lessons previously prepared by teachers using the system's lesson builder software. The digital interactive visual lesson library is further adapted for being accessed by at least one teacher to organize, personalize and download individualized visual lessons. The digital interactive visual lesson library is further adapted for being accessed by at least one teacher to download individualized visual lessons to the student device. The at least one student device being part of the web infrastructure of the subject application is adapted for interactive access and use in any location included in the web infrastructure, and at any desired time. In one embodiment, the system further includes at least one third user device for use by a student's parent. The at least one third user device allows the student's parent to communicate with teachers and the student, to access the digital interactive visual lesson library and the student's user device, and to be updated on the student's educational progress. The tablet computer enables students to communicate with parents and teachers at any location, at any time, using robust images that leverage daily experiences to improve functioning. Accompanying software modules make every experience an opportunity to teach and learn expressive/receptive communication and concept organization.

In one embodiment of the subject application, the system also includes communication means adapted for communicating, via the computer network, the customized visually-based lesson to at least one of: the first user's computing device, the second user's computing device, and the third user's computing device.

In another embodiment of the subject application, the at least one of the first user computing device, the at least one second user computing device, and the at least one third user computing device are capable of being implemented as respective portable computing devices.

In yet another embodiment of the subject application, the system also comprises receiving means adapted for receiving teacher designation data, means for receiving lesson selection data and means for receiving instruction data. In such an embodiment, the system also comprises identification means adapted for identifying a computing device associated with a selected teacher. The system of such an embodiment further includes communication means adapted for communicating selected lesson data to the identified computing device.

In yet another embodiment of the subject application, the system also comprises receiving means adapted for receiving student designation data, means for receiving lesson selection data and means for receiving instruction data. In such an embodiment, the system also comprises identification means adapted for identifying a device associated with a selected student, such as a portable device. The system of such an embodiment further includes communication means adapted for communicating selected lesson data to the identified portable device.

In yet another embodiment of the subject application, the system also comprises receiving means adapted for receiving parent designation data, means for receiving lesson selection data and means for receiving instruction data. In such an embodiment, the system also comprises identification means adapted for identifying a computing device associated with a selected parent. The system of such an embodiment further includes communication means adapted for communicating selected lesson data to the identified computing device.

Still further, in accordance with one embodiment of the subject application, there is provided an interactive visually-based educational method in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The accompanying drawings illustrate several aspects of the subject application, and together with the description, serve to explain the principles of the subject application, including:

FIG. 1A is an overall diagram of a system for generating interactive visually-based educational lessons according to one embodiment of the subject application;

FIG. 1B is a block diagram illustrating a software application included in a user device according to one embodiment of the subject application;

FIG. 2 is a block diagram illustrating a workstation for use in system for generating interactive visually-based educational lessons according to one embodiment of the subject application;

FIG. 3 is a block diagram illustrating a server for use in the system for generating interactive visually-based educational lessons according to one embodiment of the subject application;

FIG. 4 is a block diagram illustrating an example embodiment of a system for generating interactive visually-based educational lessons according to one embodiment of the subject application;

FIG. 5 is a flowchart illustrating a method for generating interactive visually-based educational lessons according to one embodiment of the subject application;

FIG. 6 is a flowchart illustrating a method for generating interactive visually-based educational lessons according to one embodiment of the subject application;

FIG. 7 is a flowchart illustrating a method for method for generating interactive visually-based educational lessons according to one embodiment of the subject application;

FIG. 8 is a flowchart illustrating a method for generating interactive visually-based educational lessons according to one embodiment of the subject application;

FIG. 9 is an illustration depicting a screen template for use in the system for generating interactive visually-based educational lessons according to one embodiment of the subject application;

FIG. 10 is an illustration depicting a screen template for use in system for generating interactive visually-based educational lessons according to one embodiment of the subject application; and

FIG. 11 is an illustration depicting a screen template for use in the system for generating interactive visually-based educational lessons according to one embodiment of the subject application.

### DETAILED DESCRIPTION OF THE PREFERRED EMBODIMENT

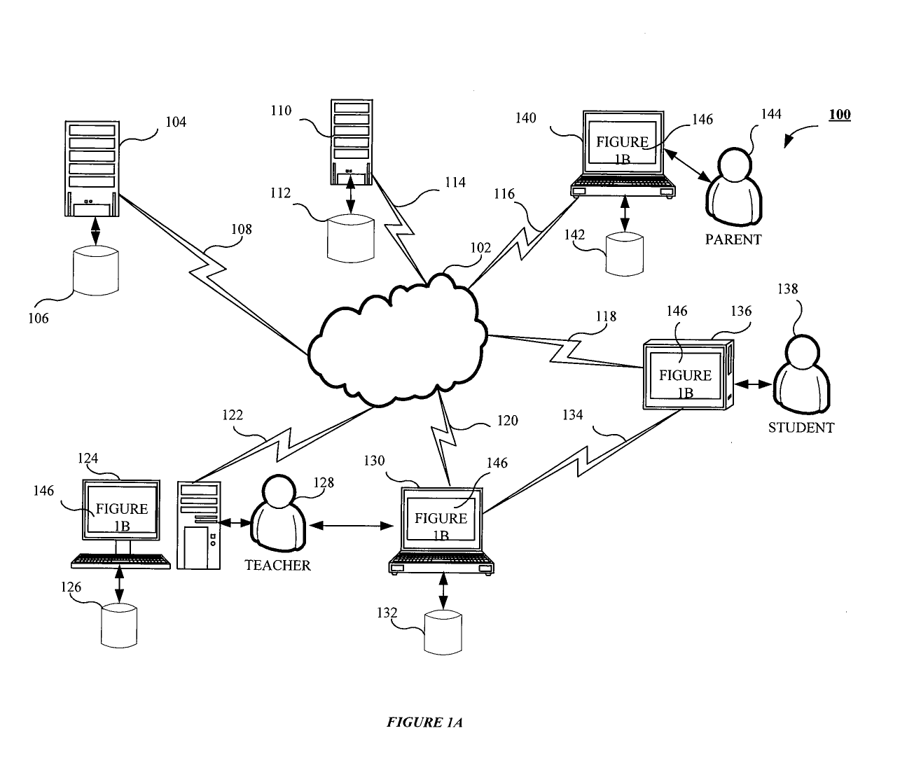

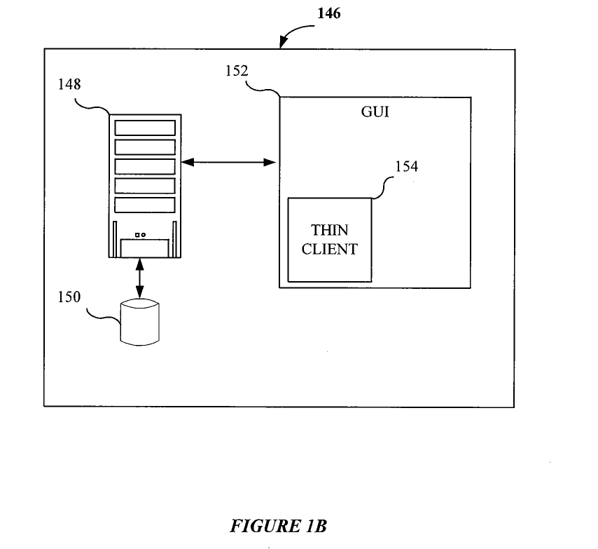

The subject application is directed to a system and method for generating interactive visually-based educational lessons. More particularly, the subject application is directed to an interactive visually-based educational system and method implemented via a computer network. The subject application is an advanced visual tool designed specifically for use in the educational process and treatment of autistic children, but can be used by any individuals and groups that prefer the permanence of visual stimuli. It will become apparent to those skilled in the art that the system and method described herein are suitably adapted to a plurality of varying electronic fields employing visually-based generic and/or personalized lesson plans, lesson content and visual support, including, for example and without limitation, communications, general computing, data processing, document processing, or the like. In accordance with one embodiment of the subject application, a lesson, as used herein, includes graphical components, audio components, text components, animation components, or any suitable combination thereof, capable of conveying education to a student. The preferred embodiment, as depicted in FIG. 1A, illustrates an education-teaching field for example purposes only and is not a limitation of the subject application solely to such a field.

Referring now to FIG. 1A, there is shown an overall diagram of an interactive educational system 100 that employs a visual language learning solution in accordance with one embodiment of the subject application. As shown in FIG. 1A, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1A, the subject application is equally capable of use in a stand-alone system, as will be known in the art.

The system 100 illustrates a network server 104 coupled to a data storage device 106. Preferably, the network server 104 is representative of any network device known in the art capable of facilitating remote access to and storage of web-based content data, document data, image data, video data, sound data, multimedia data, Individualized Education Plans (IEP), student data, personalized visual images, such as line drawings, photographs, video clips, animations, teacher/parent personalized images, and the like, previously created generic and/or specifically-targeted, personalized lesson plans, lesson content and visual support, and the like, or other suitable electronic data, as will be known in the art. Those skilled in the art will appreciate that the network server 104 is further capable of facilitating remote access to and storage of management tools, outcome reporting data, assessment data, and the like. In accordance with one embodiment of the subject application, the data storage device 106 includes a plurality of electronic data, including content libraries corresponding to image data, video data, application data, audio data, lesson template data, customized lesson files, document data, teacher account data, personalized visual images, such as line drawings, photographs, video clips, animations or the like. In accordance with one embodiment of the subject application, a lesson, file or template, as used herein, includes graphical components, audio components, text components, animation components, or any suitable combination thereof, capable of conveying education to a student in a visual expressive mode, visual instruction mode, and visual organization mode. According to one embodiment of the subject application, the data storage device 106 is any mass storage device known in the art including, for example and without limitation, magnetic storage drives, a hard disk drive, optical storage devices, flash memory devices, or any suitable combination thereof. It will be appreciated by those skilled in the art that while illustrated in FIG. 1A as being a separate component of the system 100, the data storage device 106 is capable of being implemented as internal storage component of the server 104, or the like, such as, for example and without limitation, an internal hard disk drive, or the like.

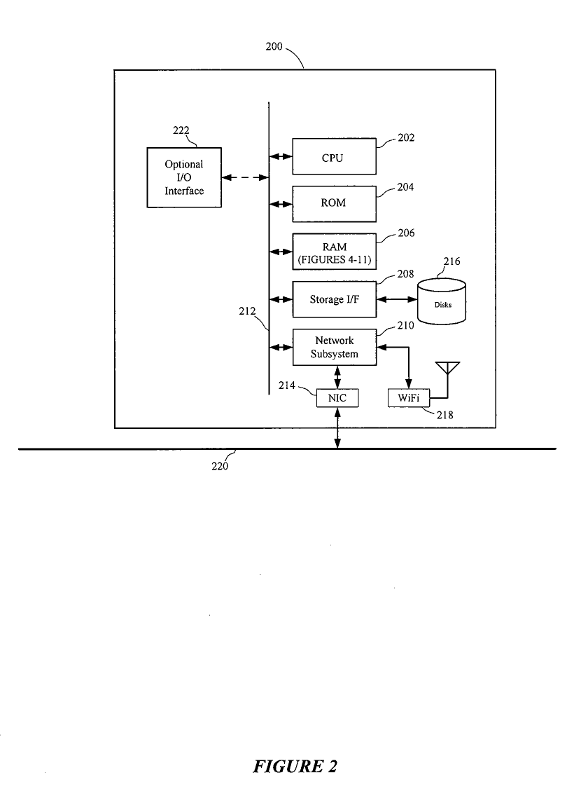

The network server 104 is communicatively coupled to the computer network 102 via a suitable communications link 108. As will be understood by those skilled in the art, the communications link 108 includes, for example and without limitation a proprietary communications network, infrared, optical, Bluetooth, WiMax, 802.11a, 802.11b, 802.11g, 802.11(x), the public switched telephone network, or any suitable wireless data transmission system, or wired communications known in the art. The operation of the network server 104 will be better understood in conjunction with the block diagram illustrated in FIG. 2, explained in greater detail below.

Further included in the system 100 is a network server 110 coupled to a data storage device 112. Preferably, the network server 110 is representative of any network device known in the art capable of facilitating remote access to and storage of document data, image data, video data, sound data, multimedia data, or other suitable electronic data, as will be known in the art. In accordance with one embodiment of the subject application, the data storage device 112 includes a plurality of electronic data, including educational standards, such as state or region curriculum requirements/standards, tutorial recommendations for specific students, and the like. According to one embodiment of the subject application, the data storage device 112 is any mass storage device known in the art including, for example and without limitation, magnetic storage drives, a hard disk drive, optical storage devices, flash memory devices, or any suitable combination thereof. It will be appreciated by those skilled in the art that while illustrated in FIG. 1A as being a separate component of the system 100, the data storage device 112 is capable of being implemented as internal storage component of the server 110, or the like, such as, for example and without limitation, an internal hard disk drive, or the like.

The network server 110 is communicatively coupled to the computer network 102 via a suitable communications link 114. As will be understood by those skilled in the art, the communications link 114 includes, for example and without limitation a proprietary communications network, infrared, optical, Bluetooth, WiMax, 802.11a, 802.11b, 802.11g, 802.11(x), the public switched telephone network, or any suitable wireless data transmission system, or wired communications known in the art. The operation of the network server 110 will be better understood in conjunction with the block diagram illustrated in FIG. 2, explained in greater detail below. It will be further appreciated by those skilled in the art that the network servers 104 and 110 while illustrated in FIG. 1A as being two separate components of the system 100, are capable of being implemented as one network server, or as a plurality of respective network servers.

The system 100 illustrated in FIG. 1A also depicts a workstation 124, in data communication with the computer network 102 via a communications link 122. It will be appreciated by those skilled in the art that the workstation 124 is shown in FIG. 1A as a workstation for illustration purposes only. As will be understood by those skilled in the art, the workstation 124 is representative of any computing device known in the art, including, for example and without limitation, a laptop computer, a personal computer, a personal data assistant, a web-enabled cellular telephone, a smart phone, a proprietary network device, or other web-enabled electronic device. The communications link 122 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art.

Communicatively coupled to the workstation 124 is a data storage device 126, suitably configured for the storage of various data, such as, for example and without limitation, video files, audio files, image files, document files, generic and/or specifically-targeted, personalized lesson plans, lesson content and visual support, educational standards, such as state or region curriculum requirements/standards, tutorial recommendations for specific students, personalized visual images, such as line drawings, photographs, video clips, animations, and the like. As will be understood by those skilled in the art, the data storage device 126 is further capable of storing a plurality of software applications, depicted in FIG. 1A as a software application 146, such as web browsers, specific lesson-building/organizing and searching programs, and the like. An example of the software application 146 is illustrated in FIG. 1B and will be explained in greater detail below. In accordance with one embodiment of the subject application, the workstation 124 is capable of communicating with the server 104 and the server 110, via the computer network 102, so as to retrieve lesson-building and organizing information, images, lesson templates, personalized visual images, such as line drawings, photographs, video clips, animations, and the like, educational standards, such as state or region curriculum requirements/standards, tutorial recommendations for specific students, and the like using a suitable web browser.

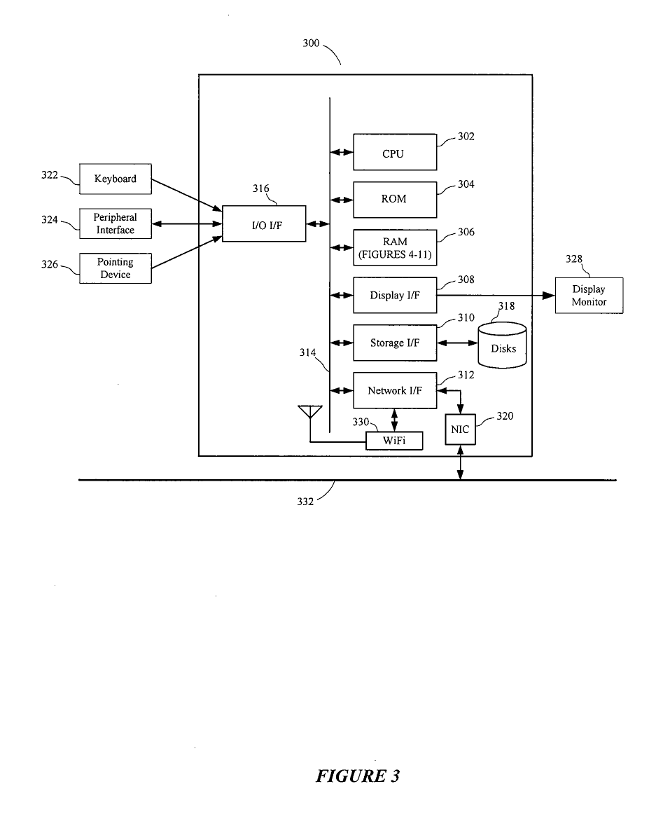

Preferably, an associated teacher 128 interacts with the workstation 124 to retrieve or create generic and/or specifically-targeted, personalized lesson plans, lesson content and visual support for an associated student 138 using a lesson building/organizing and searching application resident thereon. As will be understood by those skilled in the art, the workstation 124 is used by the teacher 128 to access files and applications stored locally, on the server 104 and on the server 110. During access of the servers 104, 110 by an associated teacher 128, lesson components, e.g., file libraries comprising components corresponding to audio, video, image, and animation files, are retrieved by the workstation 124 for incorporation into a customized lesson. The skilled artisan will further appreciate that other data, such as Individualized Education Plans (IEP), student data, personalized visual images, such as line drawings, photographs, video clips, animations, and the like, state or region curriculum requirements/standards, previously created generic and/or specifically-targeted, personalized lesson plans, lesson content and visual support, and the like, are also capable of being retrieved during access of the servers 104, 110 by the teacher 128 associated with the workstation 124. In accordance with one embodiment of the subject application, the teacher 128 is capable of establishing bi-directional communication with one or more additional teachers (not shown) during the generation of a lesson, e.g. instant messaging, text messaging, electronic mail, or the like. While reference is made herein to the teacher 128, via the workstation 124, accessing lesson creation data on the servers 104, 110, the skilled artisan will appreciate that such data is also capable of being stored locally, e.g., via the data storage device 126. The operation of the workstation 124 will better be understood in conjunction with the block diagram illustrated in FIG. 3, explained in greater detail below.

The system 100 illustrated in FIG. 1A further depicts a student device 136, in data communication with the computer network 102 via a communications link 118. It will be appreciated by those skilled in the art that the student device 136 is shown in FIG. 1A as a tablet computer for illustration purposes only. As will be understood by those skilled in the art, the student device 136 is representative of any personal computing device known in the art, including, for example and without limitation, a computer workstation, a laptop computer, a personal computer, a personal data assistant, a web-enabled cellular telephone, a smart phone, a proprietary network device, or other web-enabled electronic device. In accordance with one embodiment of the subject application, the student device 136 includes a suitable interface, as will be understood by those skilled in the art.

Preferably, the student device 136 is a ruggedized portable computer device having a touch screen display, which is capable of withstanding a variety of abuses typical in an educational setting, e.g., classroom, fieldtrips, bus rides, and the like. As will be appreciated by a skilled artisan, any other suitable screen display is capable of being included in the student device 136. In one embodiment, the student device 136 is a tablet computer that is capable of being personalized using unique colors, images, favorite characters and graphic schemes. The student device 136 is suitably adapted to receive interactive visually-based lessons and display these lessons to the student 138 for interaction thereon. The communications link 118 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art.

Further included in the system 100, as illustrated in FIG. 1A is a teacher device 130, in data communication with the computer network 102 via a communications link 120. It will be appreciated by those skilled in the art that the teacher device 130 is shown in FIG. 1A as a workstation for illustration purposes only. As will be understood by those skilled in the art, the teacher device 130 is representative of any computing device known in the art, including, for example and without limitation, a laptop computer, a personal computer, a personal data assistant, a web-enabled cellular telephone, a smart phone, a proprietary network device, or other web-enabled electronic device. The teacher device 130 is also in data communication with the student device 136 via a communications link 134. The communications links 120, 134 are any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Communicatively coupled to the teacher device 130 is a data storage device 132, suitably configured for the storage of various data, such as, for example and without limitation, video files, audio files, image files, document files, generic and/or specifically-targeted, interactive personalized lesson plans, lesson content and visual support, personalized visual images, such as line drawings, photographs, video clips, animations, and the like.

Those skilled in the art will further appreciate that the teacher device 130 represents multiple teacher devices adapted for an associated teacher 128 to interact therewith to retrieve or create generic and/or specifically-targeted, interactive personalized lesson plans, lesson content and visual support for an associated student 138 using a lesson building/organizing and searching application resident thereon. As will be understood by those skilled in the art, the teacher device 130 is used by the teacher 128 to access files and applications stored locally, e.g., via the storage device 132, or on the server 104, the server 110, the workstation 124, the teacher device 130, the student device 136, or the parent device 140. During access of respective servers and/or devices by an associated teacher 126, lesson components, e.g., file libraries comprising components corresponding to audio, video, image, animation files, and personalized visual images, such as line drawings, photographs, video clips, animations, and the like, are retrieved by the teacher device 130 for incorporation into an interactive customized lesson. The skilled artisan will further appreciate that other data, such as Individualized Education Plans (IEP), student data, state or region curriculum requirements/standards, previously created generic and/or specifically-targeted, interactive personalized lesson plans, lesson content and visual support, and the like, are also capable of being retrieved during access of the servers 104, 110, the devices 124, 136, and 140 by the teacher 128 associated with the teacher device 130. The operation of the teacher device 130 will better be understood in conjunction with the block diagram illustrated in FIG. 3, explained in greater detail below. As will be recognized by those skilled in the art, the workstation 124 is capable of being located, for example and without limitation, at a teacher's home, whereas the teacher device 130 is capable of being located, for example and without limitation, at an office, in a classroom, and the like.

As illustrated in FIG. 1A, the system 100 further includes a parent device 140 in data communication with the computer network 102 via a communications link 120. It will be appreciated by those skilled in the art that the parent device 140 is shown in FIG. 1A as a workstation for illustration purposes only. As will be understood by those skilled in the art, the parent device 140 is representative of any computing device known in the art, including, for example and without limitation, a laptop computer, a personal computer, a personal data assistant, a web-enabled cellular telephone, a smart phone, a proprietary network device, or other web-enabled electronic device. The communications links 120 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Communicatively coupled to the parent device 140 is a data storage device 142, suitably configured for the storage of various data, such as, for example and without limitation, video files, audio files, image files, document files, generic and/or specifically-targeted, interactive personalized lesson plans, lesson content and visual support, personalized visual images, such as line drawings, photographs, video clips, animations, and the like.

Preferably, an associated parent 144 interacts with the parent device 140 to check via the computer network 102 the generic and/or specifically-targeted, interactive personalized lesson plans, lesson content and visual support for an associated student 144 and also check on the progress of the associated student 144. As will be understood by those skilled in the art, the parent device 140 is used by the associated parent 144 to access via the computer network 102, files and applications stored on the server 104 and on the server 110, to access the teacher device 130 and to access the student device 136. During access of the servers 104, 110 by an associated parent 146, lesson components, e.g., file libraries comprising components corresponding to audio, video, image, and animation files, are retrieved by the parent device 138. The skilled artisan will further appreciate that other data, such as Individualized Education Plans (IEP), student data, state or region curriculum requirements/standards, previously created generic and/or specifically-targeted, interactive personalized lesson plans, lesson content and visual support, and the like, are also capable of being retrieved for use by the associated parent 144. As will be further appreciated by those skilled in the art, an associated parent 144, when authorized to do so, is also capable of interacting with the parent device 140 to access the server 104 for inputting a plurality of electronic data, including content libraries corresponding to image data, video data, application data, audio data, document data, personalized visual images, such as line drawings, photographs, video clips, animations or the like. Data that has been input by an associated parent 144 is capable of being used by an associated teacher 128 in the process of creating or customizing interactive visually-based lessons.

Those skilled in the art will recognize that teacher device 130, the student device 136, and the parent device 140 are capable of storing in corresponding data storage, a plurality of software applications, depicted in FIG. 1A as a software application 146, such as web browsers, specific lesson-building/organizing and searching programs, and the like. An example of the software application 146 is illustrated in FIG. 1B and will be explained in greater detail below.

Turning now to FIG. 1B, illustrated is a suitable software application 146 on which operations with respect to the subject application are completed. Included is a network server 148 coupled to a data storage device 150. Preferably, the network server 148 is representative of any network device known in the art capable of facilitating remote access to and storage of document data, image data, video data, sound data, multimedia data, or other suitable electronic data, as will be known in the art. In accordance with one embodiment of the subject application, the data storage device 150 includes a plurality of electronic data, including content libraries corresponding to image data, video data, application data, audio data, interactive visually-based lesson template data, customized lesson files, document data, student specific data, teacher account data, personalized visual images, such as line drawings, photographs, video clips, animations, and the like. In accordance with one embodiment of the subject application, a lesson, file or template, as used herein, includes graphical components, audio components, text components, animation components, or any suitable combination thereof, capable of conveying education to a student in a visual expressive mode, visual instructional mode, and visual organization mode. According to one embodiment of the subject application, the data storage device 150 is any mass storage device known in the art including, for example and without limitation, magnetic storage drives, a hard disk drive, optical storage devices, flash memory devices, or any suitable combination thereof.

It will be appreciated by those skilled in the art that while illustrated in FIG. 1B as being a separate component of the software application 146, the data storage device 150 is capable of being implemented as internal storage component of the server 148, or the like, such as, for example and without limitation, an internal hard disk drive, or the like. The server 148 is suitably interfaced to a user interface panel 152, which panel allows for a user to access the server 148. Access is suitably enabled via a local thin client 154 to the workstation 124, teacher device 130, student device 136, and parent device 140. As will be appreciated by a skilled artisan, access is also suitably enabled remotely via a remote thin or thick client.

Turning now to FIG. 2, illustrated is a representative architecture of a suitable server 200 on which operations of the subject system are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration, and other routines or data used for operation of the server 200.

Also included in the server 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the server 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the server 200 to communicate to other devices. The network interface subsystem 210 suitably interfaces with one or more connections with external devices to the server 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the server 200 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 222 as will be appreciated by one of ordinary skill in the art.

Turning now to FIG. 3, illustrated is a hardware diagram of a suitable workstation 300 for use in connection with the subject system. A suitable workstation includes a processor unit 302 which is advantageously placed in data communication with read only memory 304, suitably non-volatile read only memory, volatile read only memory or a combination thereof, random access memory 306, display interface 308, storage interface 310, and network interface 312. In a preferred embodiment, interface to the foregoing modules is suitably accomplished via a bus 314.

The read only memory 304 suitably includes firmware, such as static data or fixed instructions, such as BIOS, system functions, configuration data, and other routines used for operation of the workstation 300 via CPU 302.

The random access memory 306 provides a storage area for data and instructions associated with applications and data handling accomplished by the processor 302.

The display interface 308 receives data or instructions from other components on the bus 314, which data is specific to generating a display to facilitate a user interface. The display interface 308 suitably provides output to a display terminal 326, suitably a video display device such as a monitor, LCD, plasma, or any other suitable visual output device as will be appreciated by one of ordinary skill in the art.

The storage interface 310 suitably provides a mechanism for non-volatile, bulk or long term storage of data or instructions in the workstation 300. The storage interface 310 suitably uses a storage mechanism, such as storage 318, suitably comprised of a disk, tape, CD, DVD, or other relatively higher capacity addressable or serial storage medium.

The network interface 312 suitably communicates to at least one other network interface, shown as network interface 320, such as a network interface card, and wireless network interface 330, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 320 is interconnected for data interchange via a physical network 332, suitably comprised of a local area network, wide area network, or a combination thereof.

An input/output interface 316 in data communication with the bus 314 is suitably connected with an input device 322, such as a keyboard or the like. The input/output interface 316 also suitably provides data output to a peripheral interface 324, such as a USB, universal serial bus output, SCSI, Firewire (IEEE 1394) output, or any other interface as may be appropriate for a selected application. Finally, the input/output interface 316 is suitably in data communication with a pointing device interface 328 for connection with devices, such as a mouse, light pen, touch screen, or the like.

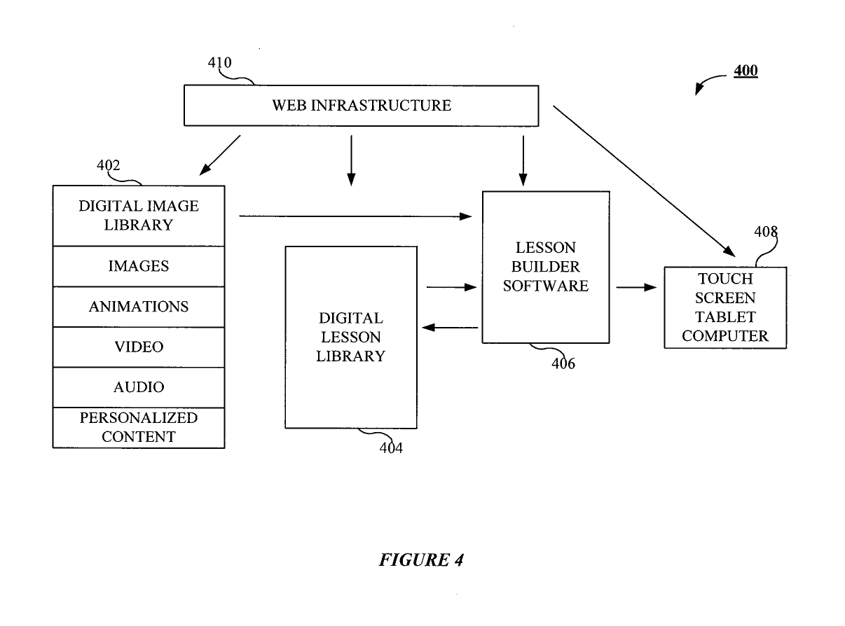

In accordance with one particular embodiment of the subject application, FIG. 4 includes a block diagram depicting an example implementation of an interactive visually-based educational system 400. Thus, the block diagram 400 of FIG. 4 illustrates additional details with respect to the contents of the libraries. The example implementation of the interactive visually-based educational system 400 illustrates a digital image library 402, a digital lesson library 404, and the corresponding interaction with the workstation 124, e.g., application software 406 corresponding to creating, organizing and searching interactive customized visually-based lessons. The teacher 128 will use the application 406, e.g., lesson organizer/builder software, running on the workstation 124 to access data in the digital image library 402 for the selection of component files for incorporation in an interactive visually-based lesson. As stated above, the digital image library 402 includes, for example and without limitation, photos, drawn images, video, audio and image components, personalized content and animations. In accordance with one particular embodiment of the subject application, the application 406, e.g., the lesson builder/organizer software, also provides searching of the digital lesson library 404 for the extraction of lesson content for creating and/or customizing interactive visually-based lessons. The digital lesson library 404 preferably includes copyright material comprising, for example and without limitation: interactive visually-based lessons and lesson templates, games, animations, assessments, individual education plans and daily schedules. The skilled artisan will appreciate that the application 406 thereby enables the teacher 128 to search, create, modify, and save new and existing visually-based generic and/or personalized lesson plans, lesson content and visual support.

As will be appreciated by those skilled in the art, FIG. 4 also illustrates the implementation of the subject application using web-based tools 410. The skilled artisan will further appreciate that the subject application enables the teacher 128 to access, develop, download, and run lessons from school, home, or any other location with internet access. In accordance with a further embodiment of the subject application, the teacher 128 is capable, via the workstation 124, of accessing student records, past lessons, and lesson results that are located anywhere on the network 102 to more individually tailor a generic and/or specifically-targeted, personalized lesson plan, lesson content and visual support for each student. The skilled artisan will appreciate that the software employed in the generation and interaction of the visually-based lessons is capable of being implemented on any suitable web-based platform, including, for example and without limitation, Adobe Flex, a Flash-based platform, Java, Windows Presentation Foundation (e.g. Silverlight), a proprietary platform, or the like.

In operation, a plurality of data, such as, for example and without limitation, video files, audio files, image files, document files, animations and the like, are first received from at least one first associated user, such as a teacher, a supervisor, and the like, via a computer network. The received data is then stored in an associated dynamic digital image library, which includes means for organizing the received data into easily identifiable and searchable categories. The searchable categories include, for example and without limitation, the following categories: parts of language, such as nouns, verbs, adjectives, and the like, associations for locations, associations for functions, and the like. In accordance with one embodiment of the subject application, data stored in the dynamic digital image library is capable of being installed initially as part of the system copyright content.

For generating interactive visually-based lessons corresponding to a plurality of curriculum categories associated therewith, the at least one first associated user, such as a teacher, a supervisor, and the like, accesses the dynamic digital image library via the computer network and searches the dynamic digital image library with respect to defined categories. Next, the at least one first associated user retrieves from the associated dynamic digital image library via the computer network, selected category data representative of a plurality of categories. The at least one first associated user further retrieves from a respective library educational standards, state or region curriculum requirements/standards, tutorial recommendations for specific students, and the like. Display data representing a plurality of interactive visually-based lessons corresponding to a plurality of curriculum categories associated therewith is then generated, which is stored in an associated digital lesson library. Data representative of interactive visually-based lessons stored in the associated digital lesson library is organized into easily identifiable and searchable curriculum categories. The searchable curriculum categories include, for example and without limitation, the following categories: academics, such as math, social studies, science, language arts, and the like, speech, activities of daily living, behavior management, and the like. This data is capable of being advantageously used as suitable interactive visually-based lesson templates.

For generating customized visually-based lessons, selection data representing at least one of a plurality of categories and subcategories, such as, for example and without limitation, academic categories, behavior categories, language, social/functional skill categories, and the like, is first received, from at least one first associated user, such as a teacher, a supervisor, and the like. The selection data is then displayed on an associated display. The selection data is capable of being displayed in a multi-layer structure. At least one of the plurality of interactive visually-based lessons corresponding to the at least one selected category is then retrieved from the associated digital interactive visual lesson library via the computer network. Display data representative of the retrieved interactive visually-based lessons is then generated. At least one of the retrieved interactive visually-based lessons is then selected for customization. A plurality of component files associated with the selected lesson is then retrieved and a display of the retrieved component files is further generated. Selection data representative of at least one component file for incorporation into the interactive visually-based lesson is further received. At least one customized interactive visually-based lesson inclusive of the selected visually-based lesson and of at least one selected component file is then generated and stored in the digital visual lesson library.

As will be appreciated by those skilled in the art, customizable components include, for example and without limitation, image type, image size, image feature, color, and the like. In accordance with one embodiment of the subject application, the at least one first associated user, such as a teacher, a supervisor, and the like, is capable of initiating a search via the network for at least one component file not associated with the selected interactive visually-based lesson, such as additional component files, graphics, and the like, which component file is capable of being included in the at least one customized interactive visually-based lesson. In accordance with one embodiment of the subject application, the interactive visually-based lessons are then organized into respective personalized folders to provide user-friendly access to the interactive visually-based lessons. In one embodiment, drag-and-drop functionality makes it easy to move or copy interactive visually-based lessons from folder to folder.

In accordance with one example embodiment of the subject application, selection data representing at least one of a plurality of categories, such as an academic category, a behavior category, a language category, a social/functional skill category, and the like, is further received from at least one second associated user, such as a student. The selection data is then displayed on an associated display. At least one of the plurality of interactive visually-based lessons corresponding to the at least one selected category is then retrieved from the associated digital visual lesson library via the computer network. The at least one interactive visually-based lesson is, preferably, personalized. Display data representative of the retrieved interactive visually-based lessons is then generated. A plurality of component files associated with the category corresponding to the selected interactive visually-based lesson, are then retrieved and a display of the retrieved component files is further generated. The associated student then interactively accesses the at least one personalized visually-based lesson and generates new content in the interactive visually-based lesson data. The student, preferably, receives reward data, based on his progress in new content. The new content is then stored in an associated storage.

In accordance with one example embodiment of the subject application, a teacher 128 associated with the workstation 124 accesses, directly, or via the computer network 102, the server 104 for inputting a plurality of data, such as, for example and without limitation, video files, audio files, image files, document files, animations and the like, into the dynamic digital image library 402 stored in the data storage device 106. The input data is then stored in the associated dynamic digital image library 402, which includes means for organizing the received data into easily identifiable and searchable categories. The searchable categories, include, for example and without limitation, the following categories: parts of language, such as nouns, verbs, adjectives, and the like, associations for locations, associations for functions, and the like. As will be appreciated by those skilled in the art, data stored in the dynamic digital image library 402 upon authorization, is capable of being accessed by a plurality of authorized associated users, such as teachers, supervisors, and the like.

In accordance with one example embodiment of the subject application, for generating interactive visually-based lessons corresponding to a plurality of curriculum categories associated therewith, the teacher 128 associated with the workstation 124 accesses, directly, or via the computer network 102, the server 104 for retrieval from the associated dynamic digital image library 402 via the computer network 102, selected category data representative of a plurality of categories, previously stored the data storage device 106, for example and without limitation, parts of language, such as nouns, verbs, adjectives, and the like, associations for locations, associations for functions, and the like. Next, the teacher 128 associated with the workstation 124 accesses, directly, or via the computer network 102, the server 110 for retrieval from the associated standard library, a plurality of electronic data, including educational standards, state or region curriculum requirements/standards, tutorial recommendations for specific students, and the like. Display data representing the plurality of categories, and the plurality of educational standards, is then generated and used by the teacher 128 for generating a plurality of interactive visually-based lessons corresponding to the plurality of curriculum categories associated therewith. The plurality of interactive visually-based lessons is then stored in the digital lesson library 404, which is capable of being associated with the server 104 and stored, for example and without limitation, in the data storage device 106. Data representative of interactive visually-based lessons stored in the associated digital lesson library 404 is organized into easily identifiable and searchable curriculum categories. The searchable curriculum categories include, for example and without limitation, the following categories: academics, such as math, social studies, science, language arts, and the like, speech, activities of daily living, behavior management, and the like. This data is capable of being advantageously used as suitable interactive visually-based lesson templates. As will be appreciated by those skilled in the art, interactive visually-based lessons stored in the digital lesson library 404 are capable of being accessed by a plurality of authorized associated users, such as teachers, supervisors, and the like.

When customization of one or more interactive visually-based lessons is required, the teacher 128 associated with the workstation 124 accesses, directly, or via the computer network 102, the server 104 for searching and the retrieval of the previously stored interactive visually-based lesson or lessons. Those skilled in the art will recognize that the teacher 128 associated with the workstation 124 at this point is also capable of accessing the server 110 for the retrieval of necessary educational standards. Preferably, the workstation 124 is operative to run a lesson building/organizing and searching software application in accordance with the subject application to facilitate the customization of an interactive visually-based lesson. As mentioned above, a lesson, as used herein, includes various libraries inclusive of graphical components, audio components, text components, animation components, or any suitable combination thereof, capable of conveying education to a student in a visual expressive mode, visual instructional mode, and visual organization mode. The server 104 then retrieves, via a suitable web-based interface operative on the workstation 124, category data representing those curriculum categories of generic and/or specifically-targeted, interactive personalized lesson plans, lesson content and visual support capable of being generated in accordance with the subject application. The curriculum category data includes, for example and without limitation, academic category, a behavior category, a language category, a social/functional skill category, and the like.

In accordance with one example embodiment of the subject application, each curriculum category includes corresponding libraries inclusive of various image, audio, video, and animation components, associated with the subject matter of the category. The workstation 124 then generates, as will be understood by those skilled in the art, a display to the teacher 128 corresponding to each of the categories retrieved. The teacher 128 is then prompted via the display of the workstation 124 to select a desired curriculum category. Upon receipt of a selected curriculum category, the workstation 124 requests, from the server 104, interactive visually-based lessons corresponding to the curriculum category. Preferably, the server 104, via the data storage device 106, stores a plurality of interactive visually-based lesson templates, with each interactive template stored in association with a specific category. The server 104 retrieves the interactive visually-based lesson templates corresponding to the selected curriculum category and communicates these interactive visually-based lesson templates to the workstation 124 via the computer network 102. It will be appreciated by those skilled in the art that while reference is made herein to retrieval of category data and interactive visually-based lesson templates from the server 104, the data storage device 126 is also capable of storing such data, thereby bypassing the need to retrieve such information from the server 104.

The workstation 124 then receives the interactive visually-based lesson templates corresponding to the selected curriculum category and displays these interactive visually-based lesson templates to the teacher 128 for a selection thereof. Preferably, the interactive visually-based lesson templates are displayed in a descriptive manner, so as to enable the teacher 128 to readily ascertain a desired type of interactive visually-based lesson content, teaching-level, or the like. The teacher 128 is then prompted, via the workstation 124, to select a desired interactive visually-based lesson template for further modification or usage. As will be appreciated by those skilled in the art, the teacher 128 is capable of selecting an interactive visually-based lesson template, a previously generated interactive visually-based lesson, or the like. Once the selection has been received by the workstation 124 from the teacher 128, the workstation 124 retrieves component files from the associated libraries on the server 104 corresponding to the selected interactive visually-based lesson. That is, the workstation 124 communicates the selected visually-based lesson information to the server 104, which thereafter retrieves audio files, image files, animation files, video files, or the like, from the libraries associated with the selected interactive visually-based lesson. The component files are then communicated from the server 104 to the workstation 124 via the computer network 102.

The workstation 124 then generates a display representing the received component files, such as graphical components, audio components, text components, animation components, other lesson variables, thereby enabling the teacher 128 to select one or more such component files for modifying. The selected component files are then modified if necessary, and added to the selected interactive visually-based lesson, whereupon the workstation 124 generates a customized, interactive visually-based lesson using the selected interactive visually-based lesson and component files. The customized interactive visually-based lesson is then communicated to the server 104 for storage thereon in the digital lesson library 404. In accordance with one embodiment of the subject application, the customized interactive visually-based lesson is stored locally to the workstation 124, e.g., via the data storage device 126. As will be recognized by those skilled in the art, the customized interactive visually-based lessons are equally capable of being stored in a storage device associated with the server 104, the teacher device 130, the student device 136, and the parent device 140. The subject application further enables the teacher 128 to designate the customized lesson as pertaining to a particular student, a particular disability, an activity level, or the like.

According to one example embodiment of the subject application, the teacher 128, via the workstation 124, designates a specific student 138, or student device 136, as a recipient of one or more interactive visually-based lessons stored on the server 104. The server 104 then establishes a communications channel with the student device 136 via the computer network 102. The selected interactive visually-based lesson or lessons are then communicated, via the computer network 102, from the data storage device 106 to the student device 136. The student device 136 then stores the received interactive visually-based lessons and adds the lessons to those interactive visually-based lessons already stored thereon. In accordance with teacher 128 specified instructions, the student device 136 operates to display the interactive visually-based lesson to the student 138 for interaction thereon. Once the interactive visually-based lesson is displayed the associated student 138 follows the displayed visually-based instructions, such as, for example and without limitation, performs reading, drawing and the like, uses an interactive game board. Those skilled in the art will appreciate that the associated student 138 is capable of being prompted via the display of the student device 136 to select a desired category, to a correct answer, or to input favorite data, such as video files, audio files, image files, and the like. Accomplishing the personalized interactive visually-based lesson the student 138 generates new content in the personalized interactive visually-based lesson, the student 138 is working on. As such, the student 138 receives reward data based on progress in new content. As will be appreciated by those skilled in the art, the reward data is capable of being, for example and without limitation, an image of candy, of a favorite toy, and like. The new content is stored in an associated storage for further use. Reward data, such as “first-then” is typically used to help students who are unable to continue with an activity due to problems with anxiety, attention, obsessions, or other interfering behaviors.

According to one example embodiment of the subject application, an associated parent 144, via the parent device 140 interacts with the student device 136 to check the generic and/or specifically-targeted, personalized lesson plans, lesson content and visual support for an associated student 138 and also check on the progress of the associated student 138. As will be appreciated by those skilled in the art, the parent device 140 interacts with the student device 136 via the computer network 102. As will be further understood by those skilled in the art, the parent device 140 is used by the parent 144 to access files and applications stored on the server 104 and on the server 110, and to access the student device 134. During access of the servers 104, 110 by an associated parent 144, lesson components, e.g., file libraries comprising components corresponding to audio, video, image, and animation files, are retrieved by the parent device 140. The skilled artisan will further appreciate that other data, such as Individualized Education Plans (IEP), student data, state or region curriculum requirements/standards, previously created generic and/or specifically-targeted, personalized lesson plans, lesson content and visual support and the like, are also capable of being retrieved for use by the associated parent 144.

According to one example embodiment of the subject application an associated parent 144, via the parent device 140 interacts with the server 104 for inputting a plurality of electronic data, including content libraries corresponding to image data, video data, application data, audio data, document data, personalized visual images, such as line drawings, photographs, video clips, animations or the like. Data that has been input by an associated parent 144 is capable of being used by an associated teacher 128 in the process of customizing interactive visually-based lessons. As will be further recognized by those skilled in the art, the student device 136 and the parent device 140, when authorized to do so, are capable of communicating with the workstation 124, as well.

In accordance with a further embodiment of the subject application, the teacher 128, parent 144, or the student 138 are capable of receiving, from the server 104, data representing a suggested course or avenue of education, such as modifications and additional lesson material. In such an embodiment, the server 104 receives progress data corresponding to each student using the system 100, such that the server 104 is capable of ascertaining a student level associated with each student. Thereafter, the server 104, provides recommendations based upon the level of the student 138 in accordance with courses, lessons, and the like, associated with another student (not shown) having the same or similar level. Thus, the skilled artisan will appreciate that the subject application is capable of targeting or suggesting interactive visually-based lessons to the teacher 128 based upon results gathered and reported by other teachers associated with students of the same or similar educational level. Preferably, such data retrieved and stored by the server 104 is communicated in a non-identifiable manner, such that the teacher 128 is not provided, nor has access to, personal data associated with other students.

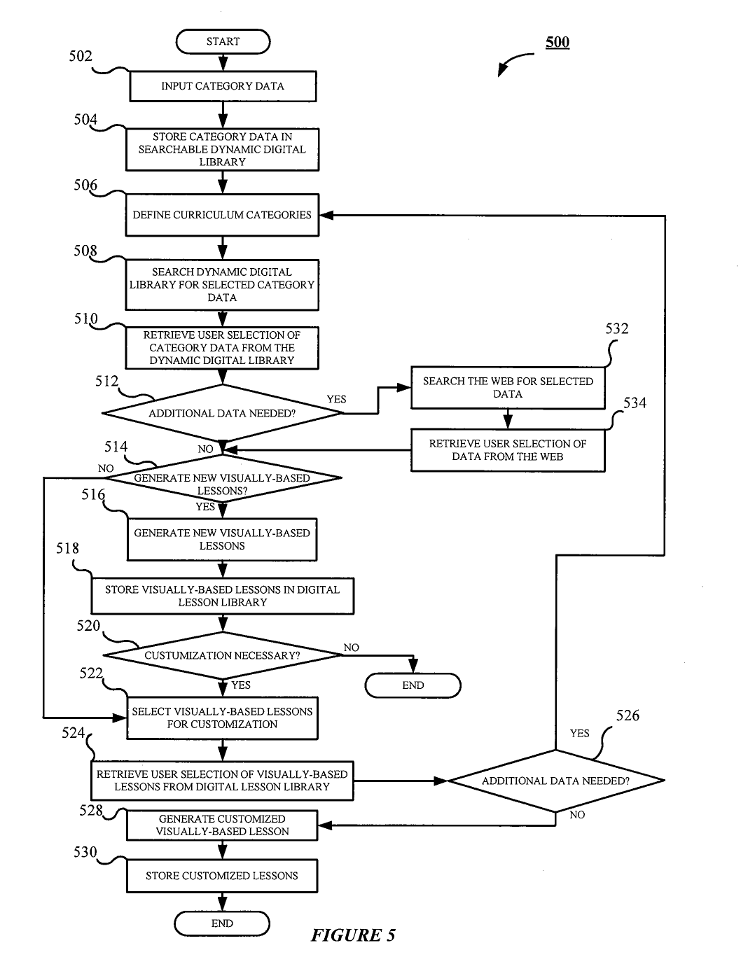

The skilled artisan will appreciate that the subject system 100 and components described above with respect to FIG. 1A, FIG. 1B, FIG. 2, FIG. 3, and FIG. 4 will be better understood in conjunction with the methodologies described hereinafter with respect to FIG. 5.

Turning now to FIG. 5, there is shown a flowchart 500 illustrating an interactive visually-based educational method in accordance with one embodiment of the subject application. Beginning at step 502, at least one first associated user, such as a teacher 128 associated with the workstation 124 and with the teacher device 130, or an authorized parent 144 associated with the parent device 140, inputs directly, or via the computer network 102, a plurality of data, such as, for example and without limitation, video files, audio files, image files, document files, interactive visually-based lesson templates, animations and the like, to an associated dynamic digital image library. Those skilled in the art will appreciate that this input data is also capable of being installed initially as part of the system copyright content. At step 504, input data is stored in the dynamic digital image library 402 of the network server 104. The dynamic digital image library 402 includes means for organizing the received data into easily identifiable and searchable categories. As will be appreciated by those skilled in the art, data stored in the dynamic digital image library 402 of the network server 104 is capable of being accessed by a plurality of authorized associated users, such as multiple teachers, supervisors, parents and the like.

For initiating the creation of interactive visually-based lessons, an associated user, such as a teacher 128 associated with the workstation 124 and with the teacher device 130, defines, at step 506, searchable curriculum categories, and at step 508, searches the digital lesson library 404 for selected category curriculum data, for example and without limitation, for example and without limitation, the following categories: academics, such as math, social studies, science, language arts, and the like, speech, activities of daily living, behavior management, and the like. Next, at step 510, the teacher 128 retrieves the selected curriculum data from the digital lesson library 404. Display data representing the plurality of categories, is then generated. At step 512, a determination is made, whether additional data stored in the dynamic digital image library 402 is needed. Upon a negative determination, flow proceeds to step 514. At step 514 a determination is made, whether additional data is needed, such as additional category data not comprised in the dynamic digital image library 402, educational standards, state or region curriculum requirements/standards, tutorial recommendations for specific students, and the like.

If the determination is negative, flow proceeds to step 516, at which step a determination is made, whether new interactive visually-based lessons are to be generated. Once the determination at step 516 is positive, new interactive visually-based lessons are generated at step 518 based on the retrieved user selection of curriculum category data. A lesson, as used herein, includes various libraries inclusive of graphical components, audio components, text components, animation components, or any suitable combination thereof, capable of conveying education to a student in a visual expressive mode, visual instructional mode, and visual organization mode. The new interactive visually-based lessons are stored, at step 520 in the digital lesson library 404 of the network server 104.

At step 522 a determination is made, whether customization of any interactive visually-based lessons is necessary. If a determination is negative, the process terminates. Once a determination is positive at step 522, flow proceeds to step 524, at which step the teacher 128 selects interactive visually-based lessons for customization. As will be recognized by those skilled in the art, the selection is capable of being made via the workstation 124, or the teacher device 130. At step 526, the user selection of the interactive visually-based lessons is retrieved from the digital lesson library 404 and displayed to the teacher 128. Next, at step 528, a determination is made whether additional information is needed for customization. If the determination is negative, that is all information necessary for customization is already available, such as, for example and without limitation, at the workstation 124, at the teacher device 130, and the like, flow proceeds to step 530. At step 530, customized interactive visually-based lessons are generated and stored in the digital lesson library 404 at step 532.

Returning now to step 512, when a positive determination is made, that is when additional data stored in the dynamic digital image library 402 is needed, for example and without limitation, photos, drawn images, video, audio and image components, personalized content and animations, and the like, flow proceeds to step 534. A teacher 128 associated with the workstation 124 and with the teacher device 130, defines, at step 534, searchable category data, such as parts of language, such as nouns, verbs, adjectives, and the like, associations for locations, associations for functions, and the like. Once searchable category data is defined, flow proceeds to step 536, at which step an associated teacher 128 searches the digital dynamic library 402 for selected data. Upon retrieving user selection of data from the dynamic digital image library 402 at step 538, flow proceeds to steps 514 through 520 in the manner already described above.

Returning now to step 514, when a positive determination is made, that is when additional data is needed for generating interactive visually-based lessons, such as additional category data not comprised in the dynamic digital image library 402, educational standards, state or region curriculum requirements/standards, tutorial recommendations for specific students, and the like, flow proceeds to step 540, at which step a web search is provided via the computer network 102 for user selected data. Those skilled in the art will appreciate that the web search is capable of including a search via the sever 110, or any other available web-wide search engines. At step 542, user selection data is retrieved from the web search engines and flow proceeds to steps 516 through 520 in the manner already discussed above.

Returning now to step 528, when a positive determination is made, that is when additional data is needed for customization, such as additional category data, educational standards, state or region curriculum requirements/standards, tutorial recommendations for specific students, photos, drawn images, video, audio, personalized content and animations, and the like, flow proceeds to steps 512 through 516 in the manner already discussed in detail above.

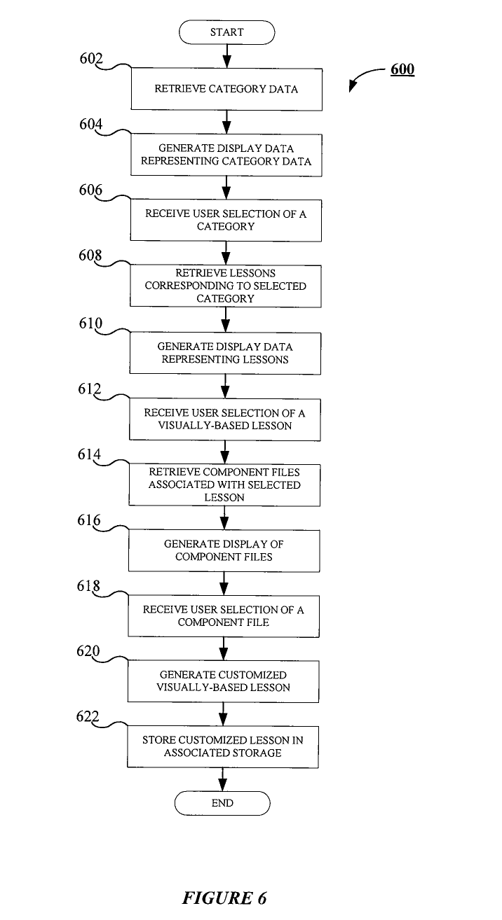

Turning now to FIG. 6, there is shown a flowchart 600 illustrating an interactive visually-based educational method in accordance with one embodiment of the subject application. Beginning at step 602, a workstation 124, via a web-based interface, retrieves category data corresponding to those categories of interactive visually-based lessons capable of being generated in accordance with the subject application from a server 104. As will be recognized by those skilled in the art, at step 602 data representative of educational standards, state or region curriculum requirements/standards, tutorial recommendations for specific students, and the like, is also capable of being retrieved by the workstation 124, via a web-based interface, when required. As mentioned previously, a lesson, as used herein, includes various libraries inclusive of graphical components, audio components, text components, animation components, or any suitable combination thereof, capable of conveying education to a student in a visual expressive mode, visual instructional mode, and visual organization mode. The category data includes, for example and without limitation, academic category, a behavior category, a language category, a social/functional skill category, and the like. In accordance with one example embodiment of the subject application, each category includes corresponding interactive visually-based lessons and interactive visually-based lesson templates inclusive of various image, audio, video, and animation components, associated with the subject matter of the category. A software application, resident on the workstation 124, then generates, via an associated display, display data representing the retrieved lesson categories at step 604.

Selection data is then received at step 606 corresponding to a teacher selection of one of the displayed lesson categories. At step 608, the workstation 124, or application resident thereon, then retrieves, from the server 104, interactive visually-based lessons corresponding to the selected category. It will be appreciated by those skilled in the art that while reference is made herein to retrieval of category data and interactive visually-based lessons from the server 104, the data storage device 126 is also capable of storing such data, thereby bypassing the need to retrieve such information from the server 104. At step 610, the workstation 124 then generates display data representing those interactive visually-based lessons retrieved corresponding to the selected category. Preferably, the interactive visually-based lessons are displayed in a descriptive manner, so as to enable the teacher 128 to readily ascertain a desired type of lesson, teaching-level appropriate lesson, or the like.

Selection data is then received from the teacher 128 at step 612 corresponding to a selection of a desired interactive visually-based lesson for further modification or usage. As will be appreciated by those skilled in the art, the teacher 128 is capable of selecting a blank interactive visually-based lesson template, a previously generated interactive visually-based lesson, or the like. At step 614, the workstation 124, via the computer network 102, retrieves component files from a library corresponding to the selected lesson/category. As will be understood by those skilled in the art, suitable component files include, for example and without limitation, audio files, image files, animation files, video files, and the like. In accordance with one embodiment of the subject application, the component files further include, for example and without limitation, quizzes, positive reinforcement audio/video/image/animation data, and the like. The retrieved component files are then displayed, at step 616, to the teacher 128 via the workstation 124. At step 618, selection data representing at least one selected component file is received from the teacher 128 by the workstation 124. At step 620, the workstation 124, via the lesson building/organizing and searching application running thereon, generates a customized, interactive visually-based lesson in accordance with the selected lesson and component files. In accordance with one embodiment of the subject application, the teacher 128 is capable of embedding a selectable component file in the lesson such that student selection thereof results in a popup display of the selectable component file. The customized interactive visually-based lesson is then stored, at step 622, in an associated storage, e.g., the data storage device 106 associated with the server 104, the data storage device 126 associated with the workstation 124, or the like.

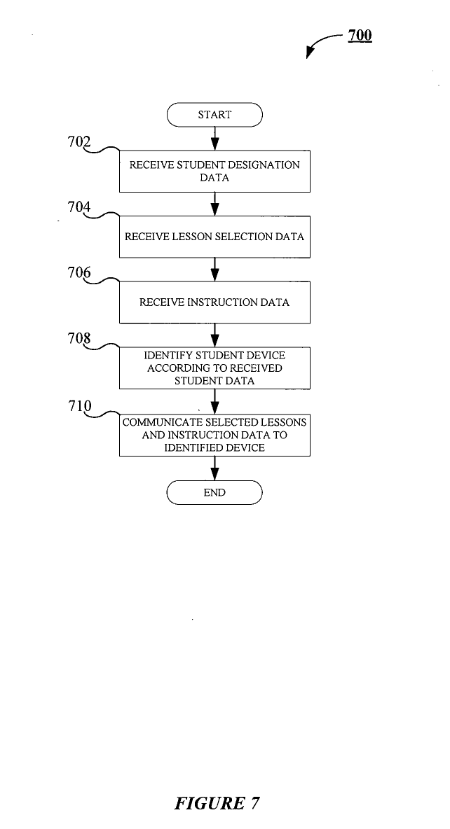

Turning now to FIG. 7, there is shown a flowchart 700 illustrating an interactive visually-based educational method from the side of the teacher 128 in accordance with one embodiment of the subject application. The method of FIG. 7 begins at step 702, whereupon the server 104 receives student designation data representing a selected student 138 or student device 136 that is to receive one or more interactive visually-based lessons. Preferably, such designation data is received by the server 104 from a teacher 128 associated with the workstation 124, the parent device 140, or student device 136 via the computer network 102. At step 704, lesson selection data is received representing one or more interactive visually-based lessons to be communicated to a selected student device 136. Such selection data is suitably received from the teacher 128 via the workstation 124 or the student device 136.

At step 706, instruction data corresponding to instructions related to the selected interactive visually-based lessons, is then received from the teacher 128 by the server 104. The server 104 then identifies, at step 708, the student device 136 corresponding to the student designation data. That is, the server 104 determines which of the student devices coupled to the computer network 102 are to receive the selected interactive visually-based lessons. The server 104 then communicates, at step 710, the selected interactive visually-based lessons to the identified student device 136 via the computer network 102. Tracking of a student's progress is also capable of being undertaken in accordance with the subject application, such that the teacher or parent is able to view student progress on a particular lesson. According to one embodiment, the teacher 128 is capable of monitoring the student's progress from a remote device 124 and thereafter interact with the student 138 via the lesson on the student device 136 during the latter's interaction with the lesson, e.g. provide examples, prompts, and the like to the student 138. According to a further embodiment of the subject application, an administrator is able to view student progress with respect to a given IEP, view reports on a teacher's or student's progress on one or more lessons, or the like. The skilled artisan will appreciate that such administrative interaction is capable of being accomplished via a suitable web-based interface.

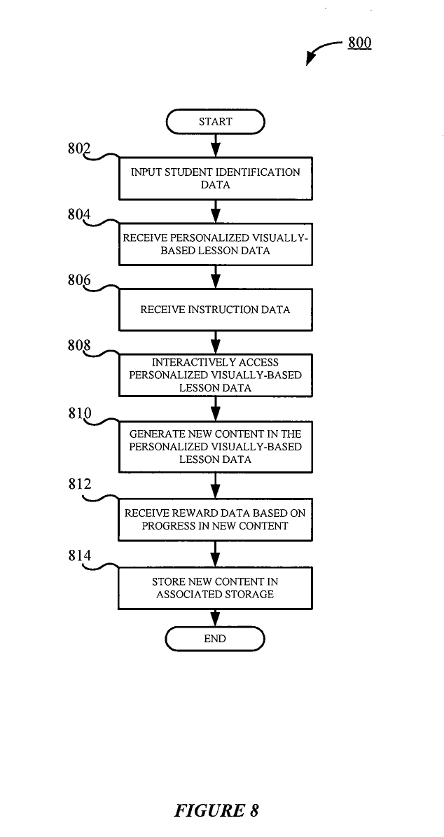

Turning now to FIG. 8, there is shown a flowchart 800 illustrating an interactive visually-based educational method from the side of the student 136 in accordance with one embodiment of the subject application. The method of FIG. 8 begins at step 802, whereupon a student 136 inputs identification data via the student device 136. As will be appreciated by those skilled in the art, identification data is capable of being input by a student via a touch screen interface. A skilled artisan will further appreciate that the identification data is capable of being, for example and without limitation, a photo of the student, a photo of the student's parent, a photo of a favorite pet, or any other image familiar to the specific student. At step 804, the student 138 receives personalized visually-based lesson data, which is displayed to the student 138. At step 806, the student 138 receives additional instruction data, such as visually-based help for progress on the visually-based lesson data. Once personalized visually-based lesson data and instruction data is received, the student 138, at step 808, interactively accesses the personalized visually-based lesson data.

Those skilled in the art will appreciate that the student 138 is capable of being prompted via the display of the student device 136 to select a desired category, to a correct answer, or to input favorite data, such as video files, audio files, image files, and the like. Accomplishing the personalized interactive visually-based lesson the student 138 generates, at step 810, new content in the personalized interactive visually-based lesson, the student 138 is working on. As such, the student 138 receives, at step 812, reward data based on progress in new content. As will be appreciated by those skilled in the art, the reward data is capable of being, for example and without limitation, an image of candy, of a favorite toy, and like. The new content is stored, at step 814, in an associated storage for further use.

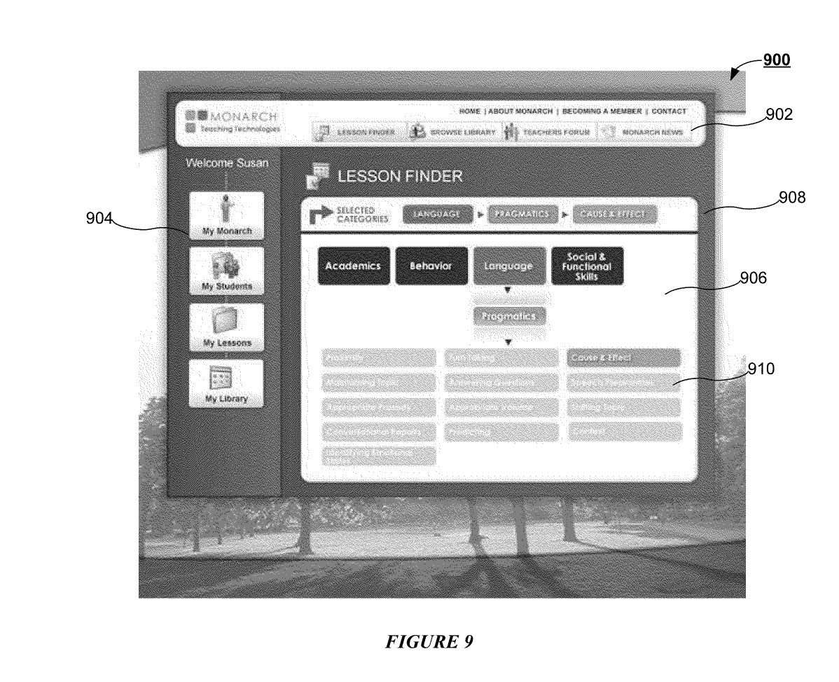

Turning now to FIG. 9, there is shown an example screen shot 900 of a graphical user interface associated with the lesson building/organizing a searching application resident on the workstation 124. It will be appreciated by those skilled in the art that the screen 900 depicted in FIG. 9 is generated via a suitable runtime platform, such as, for example and without limitation, Flash, Flex, Java, OpenLaszlo, Ajax, XUL, Silverlight, or the like. The screen 900 includes a plurality of general tabs 902 displaying options corresponding to various tasks capable of being performed in accordance with the subject application. For example and without limitation, suitable tasks include, the location of a lesson (lesson finder), browsing an image or a lesson library (browse library), communicating with another teacher (teachers forum), and a general information tab. Displayed along the left side of the template interface screen 700 is a task list 904 corresponding to tasks that are specific to the teacher 128 using the lesson building/organizing and searching application. The tasks in the task list 704 include, for example and without limitation, tasks the teacher 128 most frequently or often performs (my monarch), information on a teacher's students (my students), a teacher's library of lessons (my lessons), and a teacher's library audiovisual image and lesson library data (my library). Located in the center of the template screen 900 is an example action, wherein the teacher 128 has begun performing an operation to locate a lesson task 906. At the top of that currently performed task 906, a series of indicators 908 indicates the user has descended into the current task location by selecting first “language”, then “pragmatics” and then “cause and effect”. At the bottom of the page of the current task being performed, there is a list of other possible “pragmatics” teaching tasks 910 that are capable of being selected in place of the “cause and effect” task which was selected.

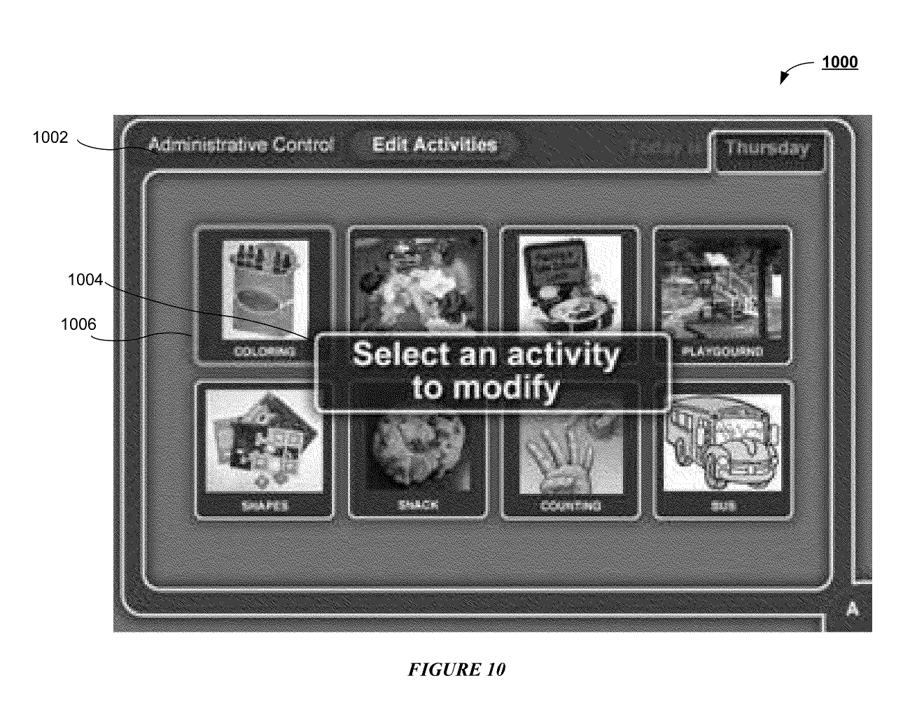

Turning now to FIG. 10, there is shown an example screen shot 1000 a template editing screen of the application operating on the workstation 124 in accordance with one embodiment of the subject application. After the user selects “Thursday” in the main tab menu 1004 at the top of the screen, the teacher 128 is shown graphic representations 806 of activities for that day and is given a prompt 1002 to select an activity to modify. The activities in this screen shot for Thursday, shown as pictorial prompts 1006, are coloring, story time, lunch time, playground time, shape learning, snack time, counting and time to go home. In this screen example 1000, coloring is represented by a picture of a box of crayons, story time is represented by a theme picture from the story, lunch time is represented by a picture of an open lunch box with food, playground time is represented by a picture of a playground, shape learning is represented by a picture of various shapes, snack time is represented by a picture of a cookie, counting is represented by a picture of counting with fingers, and time to go home is represented by a picture of a school bus.

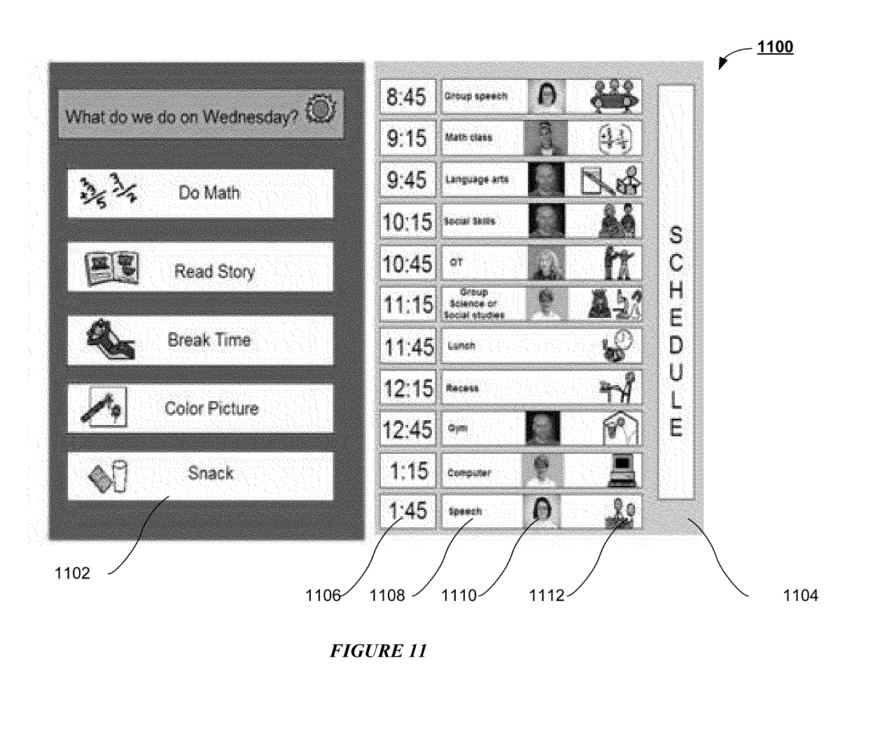

Turning now to FIG. 11, there is shown an example screen shot 1100 of the subject application interactive visually-based lessons operating on the student device 136. The screen 1100 enables the student 138 to view daily activities and interactive visually-based lessons for the current day. The screen 1100 guides the student 138 to designate a specific activity from the left side activity menu 1102 or the right side calendar menu 1104. The activity menu 1102 includes the current day's activities of “do math”, “read story”, “break time”, “color picture” and “snack”. Each activity in the menu 1102 includes a picture of the activity and the text of the activity. The right side calendar menu 1104 of the screen 1100 prompts the student 138 to select an activity within the time line of activities for the day. Each activity entry in the calendar menu 1104 includes an associated prompt depicting the activity time 1106, activity description 1108, a picture of the activity's teacher 1110, and a graphic picture representing the activity 1112.

It will be appreciated that the interactive visually-based educational system and method described herein advantageously allow for lesson standardization and lesson sharing between teachers, enable children, teachers and parents to collaborate in unique learning and communication processes using computers and a rich library of interactive visual-based lesson templates. The simple, highly engaging computer interface employed in the system maximizes each child's learning experience. Further, the interactive visually-based educational system and method of the subject application facilitates the achievement of academic goals by seamlessly integrating specific, individualized state-mandated learning objectives outlined in each student's Individualized Educational Plan. Lesson presentation via dynamic, interactive, screen-based media increases student interest and concentration and increases the comprehension and retention of key learning concepts. Hardware and software is familiarized with meaningful personal information and images to decrease anxiety and enhance motivation. Web-based access and user-friendly interface enables parents to help with homework, track their child's progress, and become intimately involved in their child's education. Portability of the user devices of the system and their being part of the web infrastructure of the subject application, the latter providing interactive access and use in any location included in the web infrastructure, and at any desired time, supports every learning experience and extends the learning process to the home and community. The interactive visually-based educational system and method of the subject application provides improved teacher-student, parent-teacher and teacher-teacher communication and collaboration and is capable of substantially reducing autism treatment costs.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for generating interactive visually-based educational lessons comprising:
receiving means adapted for receiving visually-based lesson data representative of at least one visually-based lesson via an associated computer network;
storage means adapted for storing a plurality of visually-based lessons in an associated visually-based lesson library accessible via the computer network;
organizing means associated with the visually-based lesson library configured to organize each of the plurality of stored visually-based lessons into at least one searchable lesson category, the at least one searchable lesson category comprising at least one of the group consisting of an academic category, a behavioral category, a language category, a functional category, and a skill category;
receiving means adapted for receiving component data representative of a component file, the component file including at least one of the group consisting of video data, image data, audio data, document data, and animation data;
storage means adapted for storing received component data in an associated dynamic digital library;
organizing means associated with the dynamic digital library configured to organize received component data into at least one searchable component category;
receiving means adapted for receiving selection data corresponding to at least one selected lesson category from at least one first associated user;
retrieving means adapted for retrieving category data representative of at least one category from the associated visually-based lesson library in accordance with received lesson selection data; and
generating means adapted for generating, via an associated display, display data representative of at least one visually-based lesson corresponding to the at least one selected category.

2. The system for generating interactive visually-based educational lessons of claim 1, further comprising:
receiving means adapted for receiving selection data representative of at least one selected visually-based lesson associated with the selected lesson category;
retrieving means adapted for retrieving at least one component file associated with the selected visually-based lesson;
generating means adapted for generating, via the associated display, display data representative of the at least one component file associated with the selected visually-based lesson;
receiving means adapted for receiving, from the associated user, component file selection data representative of at least one component file selected from the display thereof; and
generating means adapted for generating a customized visually-based lesson in accordance with the component file selection data and the selected visually-based lesson.

3. The system for generating interactive visually-based educational lessons of claim 2, further comprising:
retrieving means adapted for retrieving educational standard data from at least one governmental entity via the computer network; and
association means for associating the retrieved educational standard data with at least one lesson category in the associated visually-based lesson library, wherein the lesson selection data is received from the first user in accordance with the associated educational standard data.

4. The system for generating interactive visually-based educational lessons of claim 2, further comprising embedding means adapted for embedding at least one selectable component in the selected visually-based lesson, wherein the selectable component comprises at least one of the group consisting of an audio component, a video component, an image component, and an animation component.

5. The system for generating interactive visually-based educational lessons of claim 2, further comprising storage means adapted for storing the customized visually-based lesson in association with at least one of the group consisting of student data, teacher data, individualized education plan data, organization data, and governmental data.

6. The system for generating interactive visually-based educational lessons of claim 5, further comprising bi-directional communications means adapted for enabling communication between the first associated user an at least one additional user during the selection of a visually-based lesson.

7. The system for generating interactive visually-based educational lessons of claim 2, wherein the at least one searchable component category comprises at least one of the group consisting of parts of a language, location associations, function associations, and personal associations.

8. The system for generating interactive visually-based educational lessons of claim 7, wherein the at least one component retrieved in association with the selected lesson comprises at least one of the group consisting of a quiz, a positive reinforcement image component, a positive reinforcement audio component, a positive reinforcement video component, and a positive reinforcement animation component.

9. The system for generating interactive visually-based educational lessons of claim 7, wherein the stored component data includes personalized component files associated with a specific student, further comprising:
receiving means adapted for receiving student-specific data from the first associated user representative of a specific student;
retrieving means adapted for retrieving at least one personalized component file associated with the student-specific data;
generating means adapted for generating the customized visually-based lesson in accordance with the at least one component file retrieved in accordance with the student-specific data; and
storage means adapted for storing the generated customized visually-based lesson in an associated storage in accordance with the student-specific data.

10. The system for generating interactive visually-based educational lessons of claim 9, wherein the generating means further comprises incorporating means adapted for automatically incorporating personalized component files into a selected visually-based lesson so as to generate the customized visually-based lesson.

11. The system for generating interactive visually-based educational lessons of claim 10, further comprising security means adapted for securing at least one personalized component file from unauthorized access.

12. The system for generating interactive visually-based educational lessons of claim 9, further comprising communication means adapted for communicating at least one customized visually-based lesson to a portable student device via the computer network.

13. The system for generating interactive visually-based educational lessons of claim 12, further comprising:
tracking means adapted for tracking the progress of a student interacting with the at least one visually-based lesson; and
reporting means adapted for reporting tracked progress of the student upon completion of the at least one visually-based lesson to at least one of the group consisting of an administrator, a teacher, a parent, and a state organization via the computer network.

14. The system for generating interactive visually-based educational lessons of claim 13, further comprising:
monitoring means adapted for monitoring the progress of a student interacting with the at least one visually-based lesson via a remote device associated with at least one of the group consisting of an administrator, a teacher, and a parent;
selection means associated with the remote device adapted for selecting at least one additional component file for association with the at least one visually-based lesson; and
incorporating means adapted for incorporating the at least one selected additional component file into the at least one visually-based lesson during student interaction therewith.

15. The system for generating interactive visually-based educational lessons of claim 14, wherein the at least one additional component file is selected from the group consisting of a timer, a reward, a popup window, a positive reinforcement image component, a positive reinforcement audio component, and a positive reinforcement video component.

16. The system for generating interactive visually-based educational lessons of claim 13, further comprising:
reporting means adapted for reporting the tracked progress of the student to an administrator;
correlation means adapted for correlating the progress with individualized education plan data associated with the student; and
report generation means adapted for generating a report in accordance with the correlation of tracked progress and individualized education plan data.

17. The system for generating interactive visually-based educational lessons of claim 13, further comprising the steps of:
reporting means adapted for reporting the tracked progress of the student to an administrator;
correlation means adapted for correlating the progress with teacher data associated with the visually-based lesson; and
report generation means adapted for generating a report in accordance with the correlation of tracked progress and teacher data.

18. A method for generating interactive visually-based educational lessons, comprising the steps of:
receiving visually-based lesson data representative of at least one visually-based lesson via an associated computer network;
storing a plurality of visually-based lessons in an associated visually-based lesson library accessible via the computer network;
organizing each of the plurality of stored visually-based lessons into at least one searchable lesson category in the associated visually-based lesson library, the at least one searchable lesson category comprising at least one of the group consisting of an academic category, a behavioral category, a language category, a functional category, and a skill category;
receiving component data representative of a component file, the component file including at least one of the group consisting of video data, image data, audio data, document data, and animation data;
storing received component data in an associated dynamic digital library;
organizing received component data into at least one searchable component category in the associated dynamic digital library;
receiving selection data corresponding to at least one selected lesson category from at least one first associated user;
retrieving category data representative of at least one category from the associated visually-based lesson library in accordance with received lesson selection data; and
generating, via an associated display, display data representative of at least one visually-based lesson corresponding to the at least one selected category.

19. The method for generating interactive visually-based educational lessons of claim 18, further comprising the steps of:
receiving selection data representative of at least one selected visually-based lesson associated with the selected lesson category;
retrieving at least one component file associated with the selected visually-based lesson;
generating, via the associated display, display data representative of the at least one component file associated with the selected visually-based lesson;
receiving, from the associated user, component file selection data representative of at least one component file selected from the display thereof; and
generating a customized visually-based lesson in accordance with the component file selection data and the selected visually-based lesson.

20. The method for generating interactive visually-based educational lessons of claim 19, further comprising the steps of:
retrieving educational standard data from at least one governmental entity via the computer network; and
associating the retrieved educational standard data with at least one lesson category in the associated visually-based lesson library, wherein the lesson selection data is received from the first user in accordance with the associated educational standard data.

21. The method of claim 19, further comprising the step of embedding at least one selectable component in the selected visually-based lesson, wherein the selectable component comprises at least one of the groups consisting of an audio component, a video component, an image component, and an animation component.

22. The method for generating interactive visually-based educational lessons of claim 19, further comprising the step of storing the customized visually-based lesson in association with at least one of the group consisting of student data, teacher data, individualized education plan data, organization data, and governmental data.

23. The method of claim 22, further comprising the step of enabling bi-directional communication between the first associated user and at least one additional user during the selection of a lesson.

24. The method for generating interactive visually-based educational lessons of claim 19, wherein the at least one searchable component category comprises at least one of the group consisting of parts of a language, location associations, function associations, and personal associations.

25. The method of claim 24, wherein the at least one component file retrieved in association with the selected lesson comprises at least one of the group consisting of a quiz, a positive reinforcement image component, a positive reinforcement audio component, and a positive reinforcement video component.

26. The method for generating interactive visually-based educational lessons of claim 24, wherein the stored component data includes personalized component files associated with a specific student, further comprising the steps of:
receiving student-specific data from the first associated user representative of a specific student;
retrieving at least one personalized component file associated with the student-specific data;
generating the customized visually-based lesson in accordance with the at least one component file retrieved in accordance with the student-specific data; and
storing the generated customized visually-based lesson in an associated storage in accordance with the student-specific data.

27. The method for generating interactive visually-based educational lessons of claim 26, wherein the step of generating further comprises the step of automatically incorporating personalized component files into a selected visually-based lesson so as to generate the customized visually-based lesson.

28. The method of claim 26, further comprising the step of securing at least one personalized component file from unauthorized access

29. The method for generating interactive visually-based educational lessons of claim 26, further comprising the step of communicating at least one customized visually-based lesson to a portable student device via the computer network.

30. The method for generating interactive visually-based educational lessons of claim 29, further comprising the steps of:
tracking the progress of a student interacting with the at least one visually-based lesson; and
communicating tracked progress of the student during the at least one visually-based lesson to at least one of the group consisting of an administrator, a teacher, a parent, and a state organization via the computer network.

31. The method generating interactive visually-based educational lessons of claim 30, further comprising the steps of:
monitoring the progress of a student interacting with the at least one visually-based lesson via a remote device associated with at least one of the group consisting of an administrator, a teacher, and a parent;
selecting, via the remote device, at least one additional component file for association with the at least one visually-based lesson; and
incorporating the at least one selected additional component file into the at least one visually-based lesson during student interaction therewith.

32. The method generating interactive visually-based educational lessons of claim 31, wherein the at least one additional component file is selected from the group consisting of a timer, a reward, a popup window, a positive reinforcement image component, a positive reinforcement audio component, and a positive reinforcement video component.

33. The method generating interactive visually-based educational lessons of claim 30, further comprising the steps of:
reporting the tracked progress of the student to an administrator;
correlating the progress with individualized education plan data associated with the student; and
generating a report in accordance with the correlation of tracked progress and individualized education plan data.

34. The method generating interactive visually-based educational lessons of claim 30, further comprising the steps of:
reporting the tracked progress of the student to an administrator;
correlating the progress with teacher data associated with the visually-based lesson; and
generating a report in accordance with the correlation of tracked progress and teacher data.
